(19) United States
(12) Patent Application Publication
(10) Pub. No.: US 2017/0232591 A1
(43) Pub. Date: Aug. 17, 2017

(54) Tight Spot Socket

(71) Applicant: Larry L. Davis, JR., Soddy Daisy, TN (US)

(72) Inventor: Larry L. Davis, JR., Soddy Daisy, TN (US)

(21) Appl. No.: 15/044,544

(22) Filed: Feb. 16, 2016

(51) Int. Cl. B25B 23/12; B25B 13/06

(52) U.S. Cl. CPC B25B 23/12; B25B 13/06

(57) ABSTRACT

A socket with magnetic tip assembly for receiving and retaining a head of a fastener is provided. The magnetic socket includes a cylindrical configuration, with a first open end including said magnet to the front face of said tip, which is adapted to engage the hexagonal head of a nut or bolt.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

The present invention relates to a magnetic socket, and, more particularly, to a magnetic socket that has a magnetic attraction effect such that the workpiece is attracted by the magnetic member without detachment. This allows the user to mount and remove the workpiece.

(2) Background of the Invention

Automobile mechanics, as well as other types of repairmen, inevitably encounter the difficulties associated with bolt-tightening, nut-driving, and similar operations that must be performed within confined areas.

In an attempt to facilitate these procedures, individual magnetized tools are currently available. However, these tools are relatively expensive, and a complete tool set, such as a socket wrench set, typically consists of multiple sockets and is relatively costly. Furthermore, dual sets of tools, to cover both standard (conventional) and metric sizing, compounds the expense.

Another problem with current magnetized tools is that the misplacement or loss of a particular size tool, especially at the job site, presents a frustrating situation.

Various forms of magnetic tool support structures, including some of the general structural and operational features of the instant invention, heretofore have been provided. Examples of these previously known forms of magnetic holders are disclosed in U.S. Pat. Nos. 5,259,278, 5,916,340, 8,413,552, 4,663,998, 5,259,278, 6,925,914, 4,802,580, 3,405,377, 4,043,453, 4,150,746, 4,337,860, 4,482,049, and 4,586,616. However, these previously known forms of magnetic supports are not specifically designed to support a plurality of different size sockets therefrom in a precisely aligned row of sockets and in a manner accomplished by the holder of the present invention.

The present invention is intended to overcome these and other shortcomings of the presently available magnetic tools by providing a relatively inexpensive device with magnetic tip members that are able to keep the bolt in the socket as needed.

### SUMMARY OF THE INVENTION

In the view of the foregoing disadvantages inherent in the known types of magnetic tool support structures now present in the prior art, the present invention provides an improved socket assembly with a magnetic tip. As such, the general purpose of the present invention, which will be described subsequently in greater detail, is to provide an improved socket with a magnetic tip that has all of the advantages of the prior art, and none of the disadvantages.

A broad objective of the invention is to provide a socket assembly with a magnetic tip that is capable of easily holding an object therein, such as a bolt, so as to facilitate putting it in an operable position by manipulating the wrench on which it is fitted.

A more specific objective is to provide a socket assembly with a magnetic tip of the foregoing character that includes a magnet therein utilized for holding the object.

Another objective is to provide a socket assembly with a magnetic tip that may be utilized for holding the socket and the object therein on the wrench.

A further objective is to provide a socket of the foregoing character wherein the socket is not completely magnetic for counteracting the attraction of the other material when it is in use.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description, and should not be regarded as limiting.

These, together with other objectives of the invention and with the various features of novelty that characterize the invention, are pointed out with particularity in the disclosure. For a better understanding of the invention, its operating advantages, and the specific objectives attained by its uses, reference should be had to the accompanying drawings and descriptive matter, in which there are illustrated preferred embodiments of the invention.

### BRIEF DESCRIPTION OF THE DRAWINGS

The invention will be better understood, and objectives other than those set forth above will become apparent, when consideration is given to the following detailed description thereof. Such description makes reference to the annexed drawings, wherein:

FIG. 1 is a perspective view of a magnetic socket made according to the present invention, with other elements shown in dot-dash lines,

FIG. 2 is a cross-sectional view of the magnetic socket.

### DETAILED DESCRIPTION OF THE INVENTION

In the following detailed description, reference is made to the accompanying drawings, which form a part hereof, and in which is shown, by way of illustration, specific embodiments in which the invention may be practiced. These embodiments are described in sufficient detail to enable those skilled in the art to practice the invention, and it is to be understood that the embodiments may be combined, or that other embodiments may be utilized, and that structural and logical changes may be made without departing from the spirit and scope of the present invention. The following detailed description is, therefore, not to be taken in a limiting sense, and the scope of the present invention is defined by the appended claims and their equivalents.

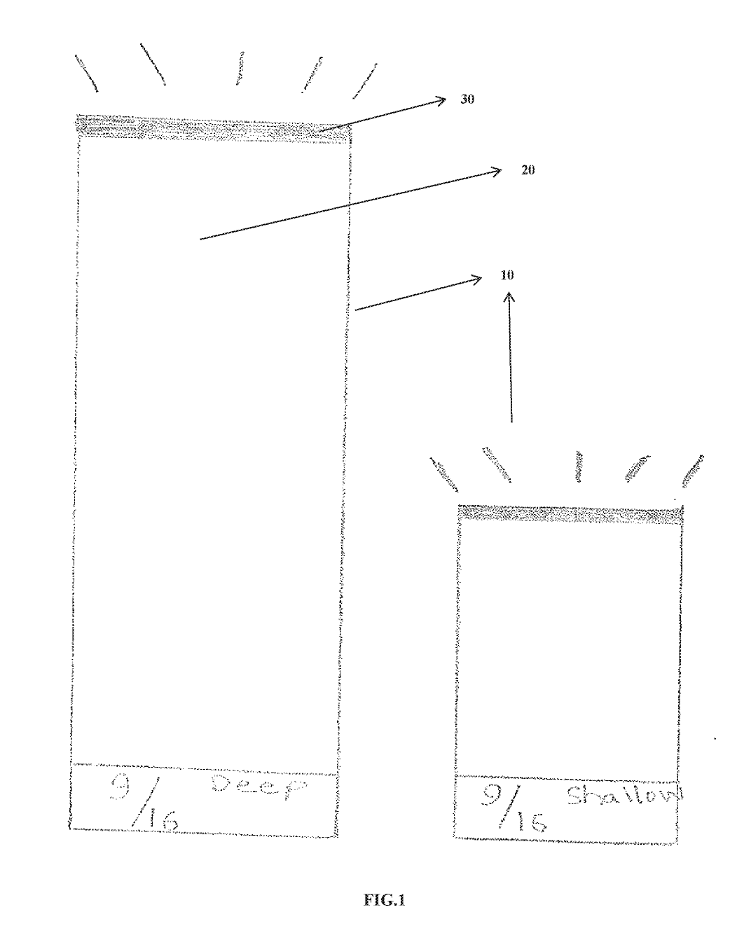

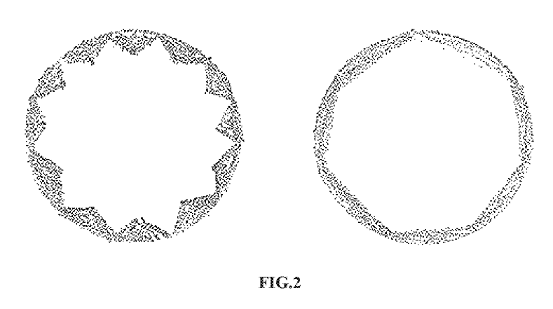

With reference to FIG. 1 and FIG. 2, the device according to the present invention is generally designated by reference numeral 10. The device 10 employs a socket 20 that has a generally cylindrical configuration. The first open end includes a magnet on the front face of the tip 30 that is adapted to engage the hexagonal head of a nut or bolt.

A magnet is fixedly attached to the front face of the tip 30 and projects far enough therefrom so that it extends slightly into a fastener-receiving cavity of socket 20 and abuts the head of the bolt. The magnet is not embedded in entire socket 20, which prevents the attraction of other materials when it is in use. According to one embodiment, the magnetic socket is available in all sizes. For example, Deep sockets and shallow socket involve 6 points and 12 points of ¾, ½, ¼, inches, etc.

When a bolt is inserted into socket 20 in a conventional manner, it is automatically retained by magnets. No additional force or step is required during insertion. The bolt can thus be positioned against a hole in a confined area without being held by a hand. The magnetic tip 30 can be used with any socket, so that it is much less expensive than providing a magnet on each socket.

It should thus be seen that a socket with magnetic tip assembly for use with socket type tools and the like is provided, which achieves the various objectives of this invention and is well adapted to meet the conditions of practical use.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages that may be provided by the present invention have been described above with regard to specific embodiments. These benefits and advantages, and any elements or limitations that may cause them to occur or to become more pronounced, are not to be construed as critical, required, or essential features of any or all of the embodiments.

While the present invention has been described with reference to particular embodiments, it should be understood that the embodiments are illustrative, and that the scope of the invention is not limited to these embodiments. Many variations, modifications, additions, and improvements to the embodiments described above are possible. It is contemplated that these variations, modifications, additions, and improvements fall within the scope of the invention.

We claim:

1. A socket with a magnetic tip assembly comprised of:
a cylindrical configuration with a first open end including a said magnet to the front face of said tip adapted to engage the hexagonal head of a nut or bolt.

2. The socket with a magnetic tip of claim 1, wherein said magnet is arranged for extending into a fastener receiving cavity of said socket and making contact with said fastener.

3. The socket with a magnetic tip of claim 1, wherein said assembly is available in different sizes.

4. The socket with a magnetic tip of claim 1, wherein said Magnetic tip used with any socket.
